(19) United States
(12) Patent Application Publication
(10) Pub. No.: US 2009/0310458 A1
(43) Pub. Date: Dec. 17, 2009

(54) OPTICAL DISK APPARATUS, INFORMATION RECORDING METHOD, SIGNAL PROCESSING LSI, AND LASER DRIVER

(75) Inventors: Koichiro Nishimura, Yokohama (JP); Masato Soma, Yokohama (JP); Toshifumi Takeuchi, Yokohama (JP); Manabu Katsuki, Yokohama (JP); Yukinobu Tada, Yokohama (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/465,770

(22) Filed: May 14, 2009

(30) Foreign Application Priority Data
May 16, 2008 (JP) 2008 -129252
May 26, 2008 (JP) 2008-136350

(51) Int. Cl. G11B 7/0045

(52) U.S. Cl. 369/59.11; G9B/7.01

(57) ABSTRACT

The present invention aims to, when recording pulse information are transmitted to a laser driver lying over a pickup through an optical disk, reduce the number of transmission paths or lines from a conventional transmission method and avoid degradation of recording performance due to transmission path characteristics upon fastening of a recording speed thereby to provide stable recording performance at high-speed recording. The invention of the present application reduces the number of transmission signals by encoding multi-level laser pulse information transmitted by the laser driver. Further, gray codes are used for encoding to reduce constraints of skew between bits. Furthermore, encoding is executed using each state transition and the state transitions are switched according to each recording mark and space, thereby reducing the occurrence of a short pulse on each transmission path. In addition, the presence or absence of the encoding is switched to enable signal transmission, thereby making it possible to make compatible adaptation to complex laser pulse information and adaptation to high-speed recording.

### CLAIM OF PRIORITY

The present application claims priority from Japanese application JP 2008-129252 filed on May 16, 2008 and JP 2008-136350 filed on May 26, 2008, the content of which is hereby incorporated by reference into this application.

### FIELD OF THE INVENTION

The present invention relates to a laser driving method for generating a laser pulse train used to optically record information in a recording medium, an integrated circuit for realizing it, and an optical disk apparatus equipped with the integrated circuit.

### BACKGROUND OF THE INVENTION

When information is recorded onto an optical disk using laser light, each recording mark is formed in a disk recording film by a laser pulse train thereby to perform information recording. The laser pulse train used at this time is called “recording strategy”.

Information about the recording strategy comprises power levels (hereinafter defined as “power levels”) of laser pulses and their pulse light-emitting timings (hereinafter defined as “pulse timings”). It is necessary to optimize these parameters according to recording conditions such as the type of optical disk, the length of each recording mark and the length of space defined therebetween, a recoding speed, etc.

In an optical disk apparatus, a laser is driven using a laser drive circuit (hereinafter described as “laser driver”) mounted onto a pickup, based on recording strategy information thereby to generate laser pulses. A method for setting the recording strategy information to the laser driver is broadly divided into the following two:

(1) In a signal processing LSI mounted onto a main substrate or board of an apparatus, information about power levels necessary to record mark and space information (NRZ information) recorded onto an optical disk and pulse timing information corresponding to the power levels are generated from the mark and space information. They are sequentially transmitted to their corresponding laser driver lying over a pickup via means such as a flexible cable thereby to generate a laser pulse train.
(2) Mark and space information (NRZ information) recorded onto an optical disk are transmitted from a signal processing LSI mounted onto a main substrate of an apparatus onto a pickup via means such as a flexible cable. Power level information and pulse timing information are generated from the mark and space information inside a laser driver thereby to generate a laser pulse train.

The configurations of (1) and (2) referred to above have been described in the following patent documents in detail.

Japanese Patent Laid-Open No. Hei 8(1996)-147697

Japanese Patent Laid-Open No. Hei 11(1999)-283249

### SUMMARY OF THE INVENTION

The above (1) is capable of suppressing heat generation of the pickup, which leads to the degradation of recording performance, since a circuit lying inside the laser driver mounted onto the pickup becomes a simple configuration comprised of only a drive current generating circuit and its switch circuit. It however involves the following problems.

(a) Since the transmission of the pulse timing information is restricted by the characteristic of the flexible cable or the like, the generation of each pulse small in time interval becomes difficult with the fastening of a recording speed.
(b) With an increase in power level, the transmission of the pulse timing information corresponding thereto is required, and the number of transmission paths or lines such as the flexible cables increases. Although differential transmission based on LVDS (Low Voltage Differential Signaling) is used for the pulse timing information in particular for the purpose of stable high-speed transmission, an increase in the transmission path is multiplied in that case.
(c) When a plurality of pulse power are added to generate pulses, it is necessary to manage or control a shift in pulse timing information between pulses to be added, so-called skew.

On the other hand, the above (2) can reduce transmission paths such as flexible cables in number because the transmission paths may cope with only NRZ or NRZ and a recording reference clock for its determination. Since the transmission of the pulse timing information is intended only for the inside of the laser driver lying over the pickup, the above (2) can avoid the problems (a) and (c) and the like and cope with the fastening of a recording speed. It however involves the following problems.

(a) Since the lengths of each mark and space are determined inside the laser driver lying over the pickup, and their power levels thereof and pulse timing information are generated thereinside, circuit processing becomes complex and the heat generation of the pickup increases, thus leading to the degradation of recording performance.
(b) Due to the reasons similar to the above, the circuit configuration of the laser driver becomes complex and the cost of the apparatus rises as compared with the method of (1) capable of incorporating the power level information and the pulse timing information into the signal processing LSI or the like of the main substrate.

The present invention is capable of solving the above problems and adapting to the fastening of a recording speed at the transmission of signals between a signal processing LSI for generating a recording strategy and a laser driver driven thereby. It is thus possible to manufacture an optical disk apparatus adapted to the fastening of the recording speed using the signal processing LSI and the laser driver. Further, the number of signals on the signal transmission paths can be reduced and the manufacture of an inexpensive optical disk apparatus is enabled.

The above problems can be solved by an optical disk apparatus which records information in a recording medium using a pulse train based on laser emission, comprising: a mark/space length discrimination circuit for discriminating mark and space lengths lying over the recording medium from the information recorded in the recording medium; a laser pulse train generating circuit for determining a shape of a laser pulse train from the output of the mark/space length discrimination circuit; a change timing signal generating circuit for outputting a plurality of change timing signals each based on a binary pulse train, indicative of change timings each corresponding to an amount of light emitted by a laser on the basis of the laser pulse train outputted from the laser pulse train generating circuit; an encode circuit for converting the change timing signals to code signals respectively, based on a predetermined conversion table and outputting each of the signals; a decode circuit for converting the code signals to a plurality of change timing signals each corresponding to an amount of light emitted by the laser respectively, based on a predetermined conversion table; and a laser drive circuit for generating a laser drive current for forming a laser pulse train, based on the change timing signals outputted from the decode circuit.

The above problems can be solved by an optical disk apparatus which records information in a recording medium using a pulse train based on laser emission, comprising: a mark/space length discrimination circuit for discriminating mark and space lengths lying over the recording medium from the information recorded in the recording medium; a laser pulse train generating circuit for determining a shape of a laser pulse train from the output of the mark/space length discrimination circuit; a change timing signal generating circuit for outputting a plurality of change timing signals each based on a binary pulse train, indicative of change timings each corresponding to an amount of light emitted by a laser on the basis of the laser pulse train outputted from the laser pulse train generating circuit; an encode circuit for converting the change timing signals to code signals respectively, based on a predetermined conversion table and outputting the signals; a first switch circuit for outputting by switching the change timing signals outputted from the change timing signal generating circuit and the code signals outputted from the encode circuit to the signal transmission path, based on the laser pulse train outputted from the laser pulse train generating circuit; a decode circuit for converting the code signals each inputted via the signal transmission path to a plurality of change timing signals each corresponding to an amount of light emitted by the laser respectively, based on a predetermined conversion table; a second switch circuit for outputting by switching the change timing signals transmitted from the change timing signal generating circuit via the transmission path and the change timing signals outputted from the decode circuit, based on the laser pulse train outputted from the laser pulse train generating circuit; and a laser drive circuit for generating a laser drive current for forming a laser pulse train, based on each of the outputs of the above switch circuits. In the optical disk apparatus, when the shape of the laser pulse train generated by the laser pulse train generating circuit is of a predetermined shape, a selection for outputting each code signal outputted from the encode circuit to the signal transmission path at the first switch circuit, an encode process at the encode circuit, a decode process at the decode circuit, and a selection for outputting the change timing signals outputted from the decode circuit to the laser drive circuit at the second switch circuit are executed, and when other than the above, a selection for outputting each of the change timing signals outputted from the change timing signal generating circuit to the signal transmission path at the first switch circuit, and a selection for outputting the change timing signals outputted from the change timing signal generating circuit to the laser drive circuit at the second switch circuit are executed.

The above problems can be solved by providing the optical disk apparatus with a state transition circuit for performing each of state transitions based on the laser pulse train generated by the laser pulse train generating circuit and thereby outputting states, and changing either one or both of conversion tables used for conversion of the change timing signals and the code signals at the encode circuit and conversion tables used for conversion of the code signals and the change timing signals at the decode circuit, based on the state outputs of the state transition circuit.

The above problems can be solved by an optical disk apparatus which records information in a recording medium using a pulse train based on laser emission, comprising: a mark/space length discrimination circuit for discriminating mark and space lengths lying over the recording medium from the information recorded in the recording medium; a laser pulse train generating circuit for determining a shape of a laser pulse train from the output of the mark/space length discrimination circuit; a change timing signal generating circuit for outputting a plurality of change timing signals each based on a binary pulse train, indicative of change timings each corresponding to an amount of light emitted by a laser on the basis of the laser pulse train outputted from the laser pulse train generating circuit; a state transition circuit for performing each of state transitions based on the laser pulse train used upon recording the information in the recording medium and thereby outputting states; an encode circuit for assigning the states of the change timing signals to predetermined codes, based on the state outputs of the state transition circuit and outputting the same as code signals; a decode circuit for changing the code signals to a plurality of change timing signals each corresponding to an amount of light emitted by the laser, based on the state outputs of the state transition circuit; and a laser drive circuit for generating a laser drive current for forming a laser pulse train, based on the change timing signals outputted from the decode circuit.

The above problems can be solved by taking each of the code signals as a multi-valued signal comprised of a multibit of 2 bits or more, and taking a continuous change in the multi-valued signal as 1 bit in the optical disk apparatus having the above configuration.

The above problems can be solved by, when a multi-valued signal changes in an arbitrary bit, realizing a change in the next multi-valued signal in a bit different from the arbitrary bit, in the optical disk apparatus having the above configuration.

The above problems can be solved by setting a time interval of a signal change produced in the same bit in the multi-valued signal to one cycle or more of a recording clock synchronized with the record data recorded in the recording medium, in the optical disk apparatus having the above configuration.

The present invention can solve the above problems and adapt to the fastening of a recording speed upon the transmission of each signal between a signal processing LSI that generates a recording strategy and a laser driver driven thereby. It is thus possible to manufacture an optical disk apparatus adapted to the fastening of the recording speed using the signal processing LSI and the laser driver. Further, the number of signals on the signal transmission paths can be reduced and the manufacture of an inexpensive optical disk apparatus is enabled.

### BRIEF DESCRIPTION OF THE DRAWINGS

FIG. 1 is a configuration diagram of blocks related to an information recording operation of an optical disk apparatus according to a first embodiment;

FIG. 2 is a diagram showing one example illustrative of a recording strategy and its generating method;

FIG. 3 is a diagram showing one example illustrative of configurations of blocks related to an information recording operation of a conventional optical disk apparatus;

FIG. 4 is a diagram showing one example illustrative of configurations of blocks related to an information recording operation of a conventional optical disk apparatus;

FIG. 5 is a diagram showing a method for transmitting recording strategy information of the optical disk apparatus according to the first embodiment;

FIG. 6 is a diagram showing an encode table of recording pulse information employed in the first embodiment;

FIG. 7 is a flowchart showing the operation of recording information onto an optical disk according to the first embodiment;

FIG. 8 is a diagram illustrating the transmission of recording pulse information employed in a second embodiment;

FIG. 9 is a diagram showing state transitions of gray codes;

FIG. 10 is a diagram illustrating an encode table of the recording pulse information employed in the second embodiment;

FIG. 11 is a diagram showing the transmission of recording pulse information employed in a third embodiment;

FIG. 12 is a configuration diagram of blocks related to an information recording operation of an optical disk apparatus according to a fifth embodiment;

FIG. 13 is a diagram showing state transitions of gray code conversion in a fourth embodiment;

FIG. 14 is a configuration diagram of blocks related to an information recording operation of an optical disk apparatus according to a sixth embodiment;

FIG. 15 is a flowchart showing the operation of recording information onto an optical disk in the sixth embodiment;

FIG. 16 is a configuration diagram of blocks related to an information recording operation of an optical disk apparatus according to a seventh embodiment;

FIG. 17 is a flowchart showing the operation of recording information onto an optical disk in the seventh embodiment;

FIG. 18 is a configuration diagram of blocks related to an information recording operation of an optical disk apparatus according to an eighth embodiment;

FIG. 19 is a flowchart showing the operation of recording information onto an optical disk in the fifth embodiment;

FIG. 20 is a diagram showing the transmission of recording pulse information in a ninth embodiment; and

FIG. 21 is a flowchart showing the operation of recording information onto an optical disk in the ninth embodiment.

### DETAILED DESCRIPTION OF THE PREFERRED EMBODIMENTS

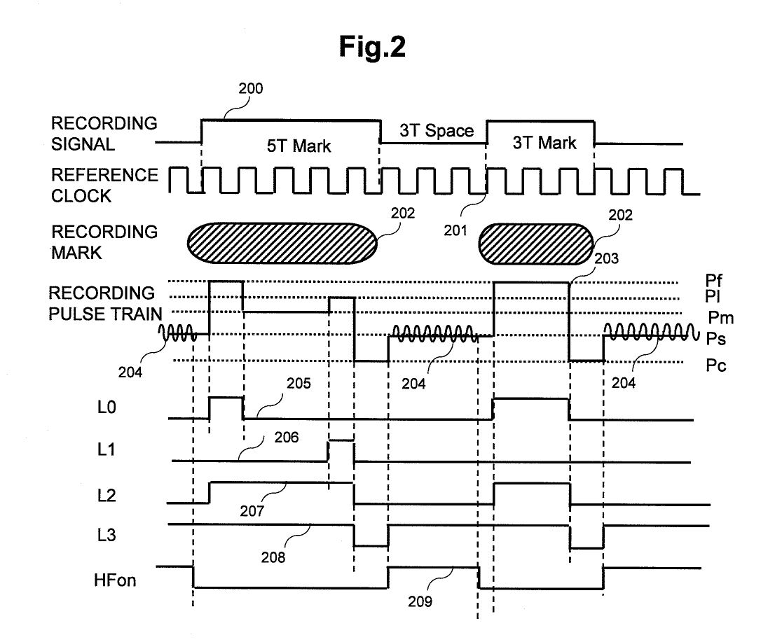

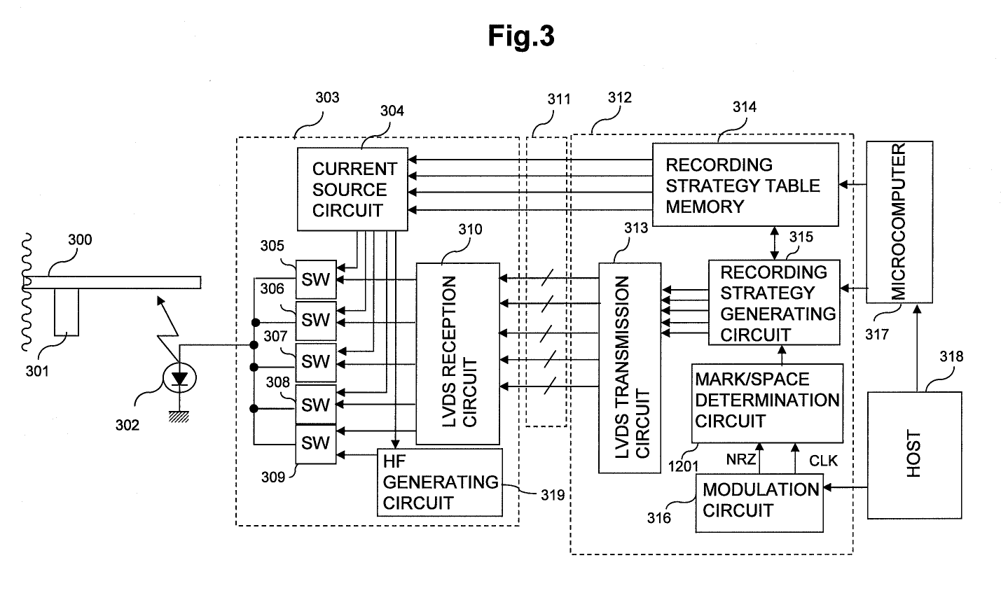

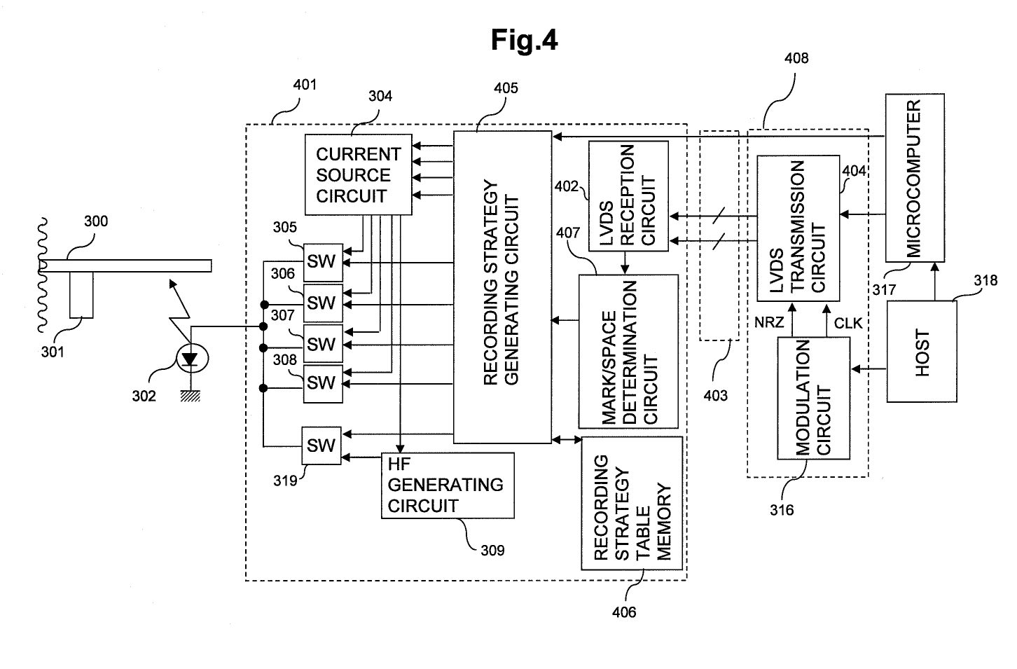

A configuration of a recording strategy and a conventional method for transmitting the same will first be explained using the drawings. FIG. 2 shows one example of a recording strategy and a method for generating the same, and FIGS. 3 and 4 respectively show conventional examples of configuration diagrams of blocks related to information recording operations of optical disk apparatuses. Similar figure numbers are respectively attached to the blocks each having a similar function in FIGS. 3 and 4. FIG. 3 corresponds to the method of (1) shown in the conventional example, and FIG. 4 corresponds to the method of (2).

When record data is inputted from an upper-level host 318 shown in each of FIGS. 3 and 4 to a modulation circuit 316, NRZ (200 in FIG. 2) and a recording clock (201 in FIG. 2, which is hereinafter described “CLK”) synchronized with NRZ, are outputted from the modulation circuit 316 lying inside a signal processing LSI 312 (or 408). In the configuration shown in FIG. 3, a mark/space determination circuit 1201 disposed inside the same LSI makes decisions as to mark and space lengths for NRZ and CLK and inputs the result thereof to a recording strategy generating circuit 315. The recording strategy generating circuit 315 reads recording strategy information corresponding to the inputted mark and space information from a recording strategy table memory 314 and thereby generates a recording strategy 203 for recording each record mark shown in FIG. 2. The generated recording strategy 203 is decomposed into waveforms each indicative of the timing provided to generate each power level and a waveform indicative of the timing provided to perform on/off switching of a high frequency superimposed waveform (hereinafter described as “HF”). In FIG. 2, pulses L0 through L3 are generated corresponding to power levels Pf, Pl, Pm and Ps, and a pulse Hfon is generated corresponding to the setting of on/off of HF. The generated pulses are converted to their corresponding LVDS signals by an LVDS transmission circuit 313, each of which in turn is transmitted to an LVDS reception circuit 310 of a laser driver 303 via a transmission path or line 311 such as a flexible cable. Each of the power levels corresponding to the respective pulses is also similarly transmitted to a current source circuit 304 of the laser driver 303 via the transmission path 311. In the laser driver 303, currents corresponding to the respective power levels are outputted from the current source circuit 304 and a high frequency superposition current is outputted from an HF generating circuit 309. These current outputs are controlled by switches 305 through 309 in accordance with the pulses received by the LVDS reception circuit 310 to perform current addition thereof, thereby generating a laser drive current to cause a laser 302 to emit laser light, after which information is recorded onto a disk 300 by the thus-obtained laser pulse train.

On the other hand, in the configuration of FIG. 4, NRZ and CLK generated inside a signal processing LSI 408 are inputted to an LVDS transmission circuit 404 and inputted to an LVDS reception circuit 402 lying within a laser driver 401 via a transmission path or line 403 such as a flexible cable as LVDS signals. A mark/space determination circuit 407 mounted inside the laser driver makes decisions as to mark and space lengths about the received NRZ and CLK and inputs the result thereof to a recording strategy generating circuit 405. The recording strategy generating circuit 405 and a recording strategy table memory 406 referred to thereby respectively have functions similar to those designated at reference numerals 315 and 314 in the description of FIG. 3. Since the operations of allowing a laser 302 to emit laser light and recording information onto a disk 300 are similar to the description of FIG. 3 subsequently, their explanations are omitted herein.

Best modes for carrying out the present invention will next be explained using the accompanying drawings.

### First Embodiment

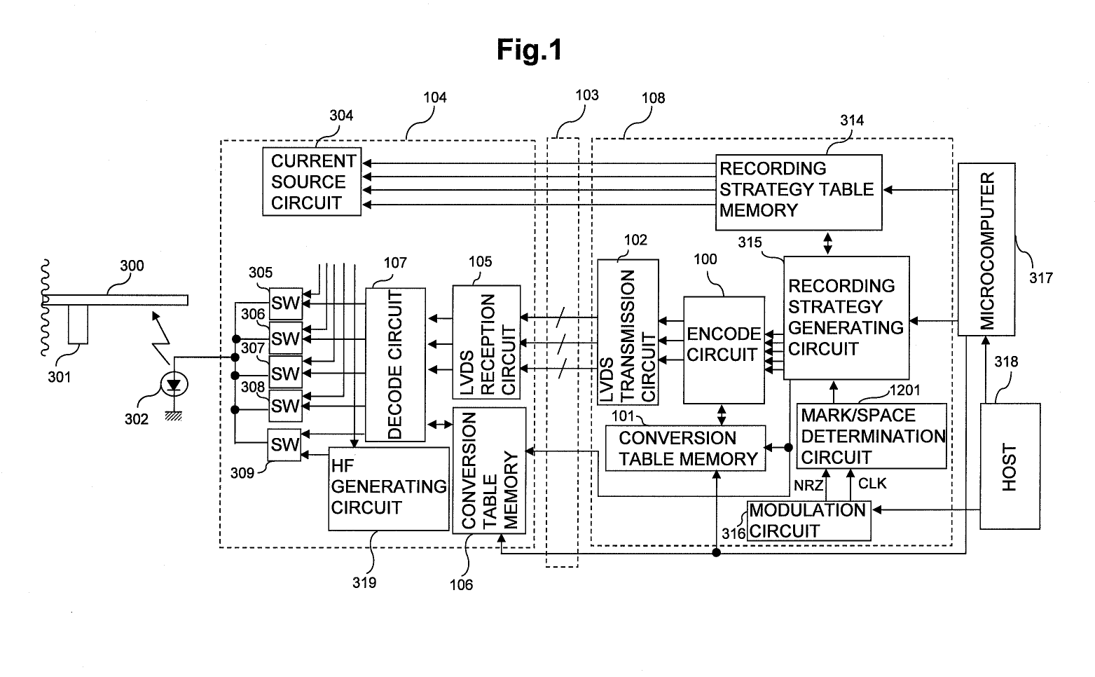

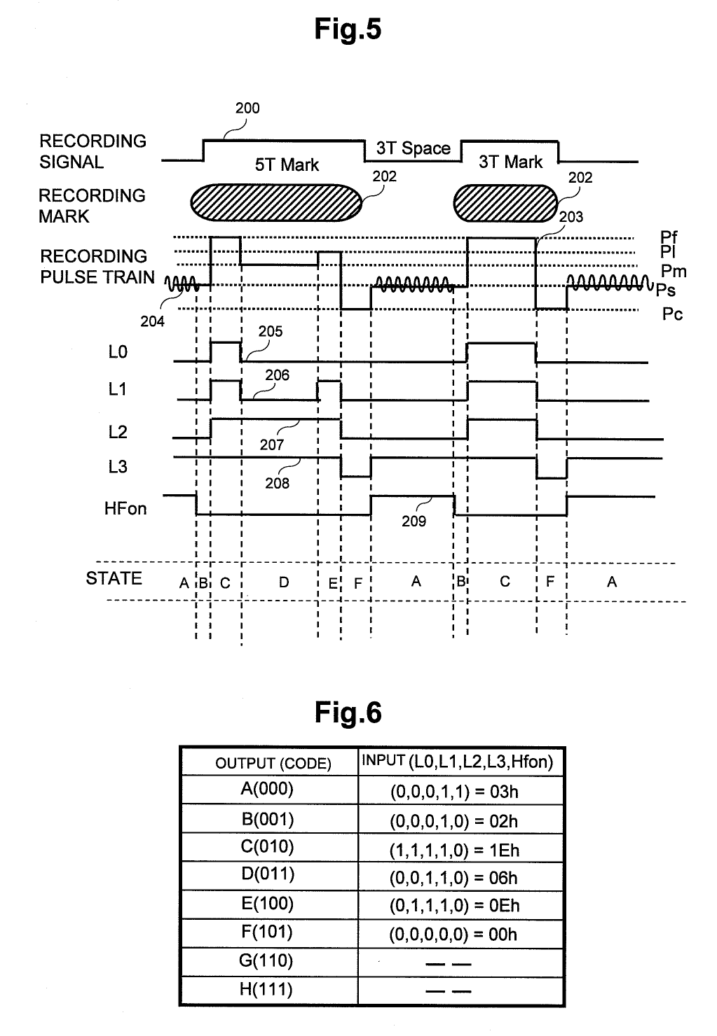

A configuration diagram of blocks related to an information recording operation of an optical disk apparatus according to a first embodiment of the present invention is shown in FIG. 1. In the same figure, the blocks having the same functions as those shown in FIGS. 3 and 4 are given similar figure numbers, and their explanations are omitted. FIG. 5 shows a method for transmitting recording strategy information in the present embodiment.

Recording strategy transmission according to the present embodiment will be described below using FIGS. 1 and 5.

Pulse groups L0 through L3 and Hfon generated at a recording strategy generating circuit 315 in a manner similar to FIG. 3, based on record data from an upper-level host 318 are inputted to an encode circuit 100. Assuming that the states of pulses indicated at L0 through L3 and Hfon are expressed in bits and their combinations, it is possible to obtain or acquire 32 states in 5 bits as a whole. In the case of such a castle type strategy as shown in FIG. 2, however, the number of states used when a recording strategy is actually generated, is six. Although there is known a strategy using a multipulse in addition to the above as the form of each recording strategy, the number of states used in optical disk recording is eight or so at the most even in either case. From this point of view, the encode circuit 100 encodes the states of 5 bits expressed in the combinations of the pulse groups (hereinafter assumed to be recording pulse information) to 3-bit codes. An example of a conversion table at that time is shown in FIG. 6. This encode table needs to be optimized according to the form of the recording strategy in order to reduce the number of states of the recording pulse information. Conversion tables corresponding to respective recording strategies are stored in a conversion table memory 101 shown in FIG. 1. The optimum conversion table is selected by a command issued from the recording strategy generating circuit to perform conversion at the encode circuit 100. Incidentally, the conversion tables stored in the conversion table memory 101 are rendered settable programmably by software or the like that performs control of the optical disk apparatus. The converted 3-bit codes are converted to their corresponding LVDS signals by an LVDS transmission circuit 102. Each of the converted LVDS signals is outputted from a signal processing LSI 108 and inputted to an LVDS reception circuit 105 of a laser driver 104 mounted onto a pickup via a transmission path or line 103 such as a flexible cable. The LVDS signals received at the LVDS reception circuit are inputted to a decode circuit 107. The decode circuit 107 reads a conversion table similar to each conversion table used inside the signal processing LSI 108 from a conversion table memory 106 lying inside the laser driver 104 and thereby restores the recording pulse information of L0 through L3 and Hfon from the inputted codes. In order to realize this processing, the conversion table memory 106 lying inside the laser driver 104 is made settable programmably from a microcomputer 318 by firmware or the like that performs control of the optical disk apparatus in a manner similar to the conversion table memory 101. The same contents as those in the conversion table memory 101 are registered in the conversion table memory 106. The emission of laser light by a laser 302 and the recording of information onto a disk 300 are subsequently similar to the above explanations in FIG. 3.

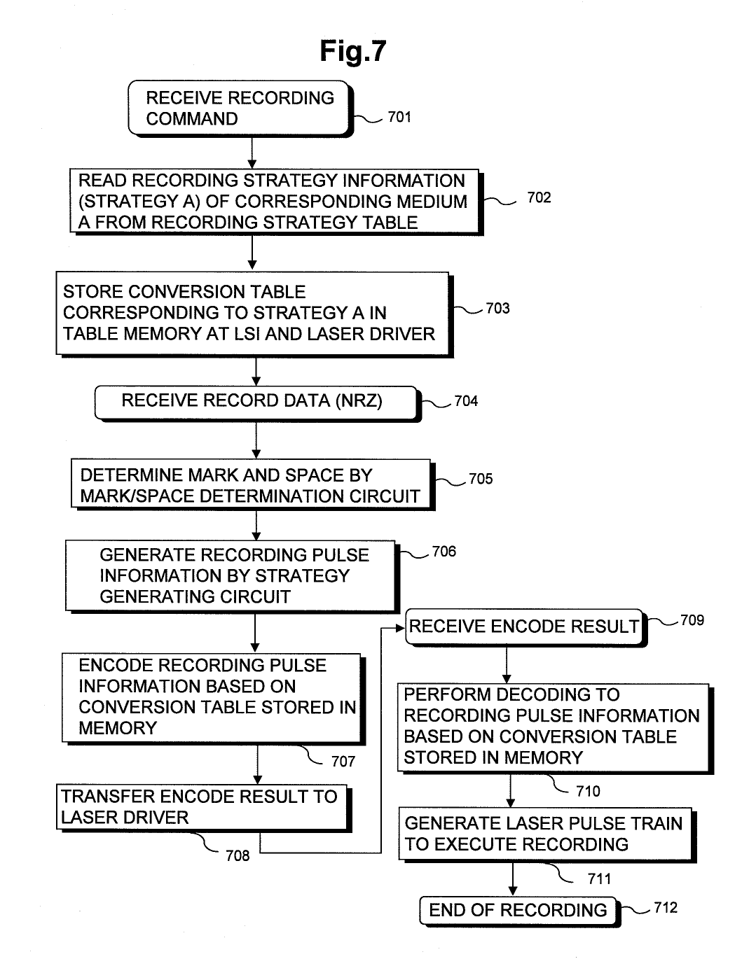

A flowchart showing the operation of recording information onto an optical disk by the above recording strategy transmission is shown in FIG. 7. When a record command and record data are received from the upper-level host (701), recording strategy information (assumed to be “strategy A”) of the corresponding disk is read from its corresponding recording strategy table (702). Next, a conversion table corresponding to the strategy A is set onto its corresponding conversion table mounted onto the signal processing LSI and the laser driver (703). Each conversion table is set programmably from the microcomputer by the firmware or the like that performs the control of the optical disk apparatus. Next, NRZ corresponding to the record data is inputted from the modulation circuit to the mark/space determination circuit (704). The result of determination is inputted to the strategy generating circuit (705) from which recording pulse information are generated (706). In the encode circuit lying inside the signal processing LSI, the recording pulse information are encoded based on the conversion table set at 701 referred to above and transmitted to the laser driver (708). In the laser driver, the decode circuit performs decoding from the received result of encode (709), based on the conversion table set at 703 referred to above thereby to generate recording pulse information (710), after which a laser pulse train is outputted to execute recording (711, 712).

In the present embodiment, the signals transferred between the signal processing LSI and the laser driver are encoded thereby to make it possible to transmit the same with the coded three pulses as an alternative to the case where the pulse timing information have heretofore been transmitted in the form of the five recording pulse information. Encoding the signals transmitted between the signal processing LSI and the laser driver in this way makes it possible to reduce the number of signal lines in the transmission path and reduce the number of pins for the signal processing LSI and the laser driver LSI.

### Second Embodiment

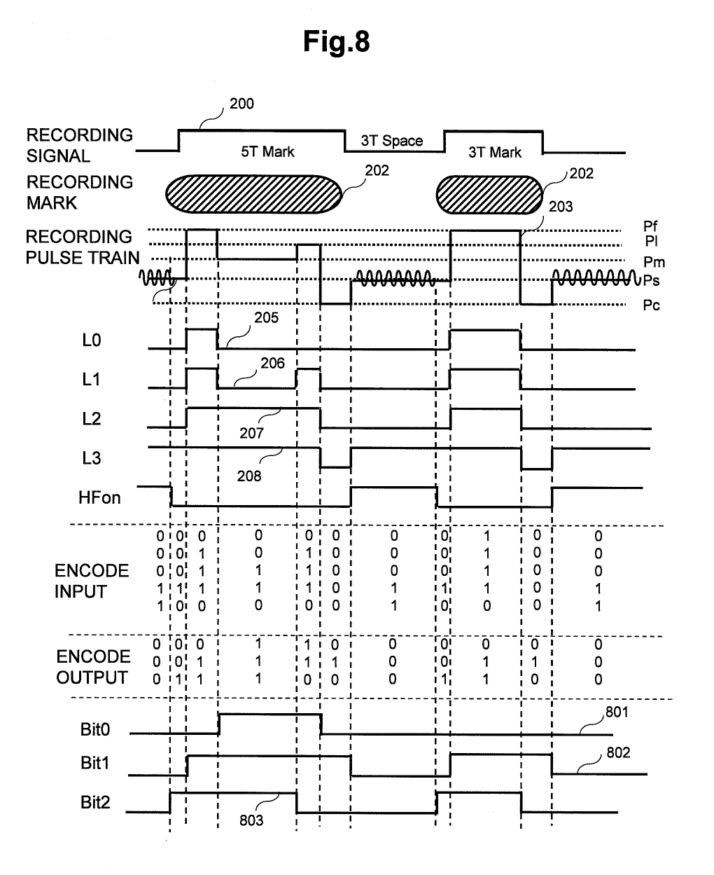

A diagram illustrative of the transmission of recording pulse information employed in a second embodiment of the present invention is shown in FIG. 8. In the same figure, similar figure numbers are respectively attached to portions similar to those shown in FIG. 5, and their explanations are omitted herein.

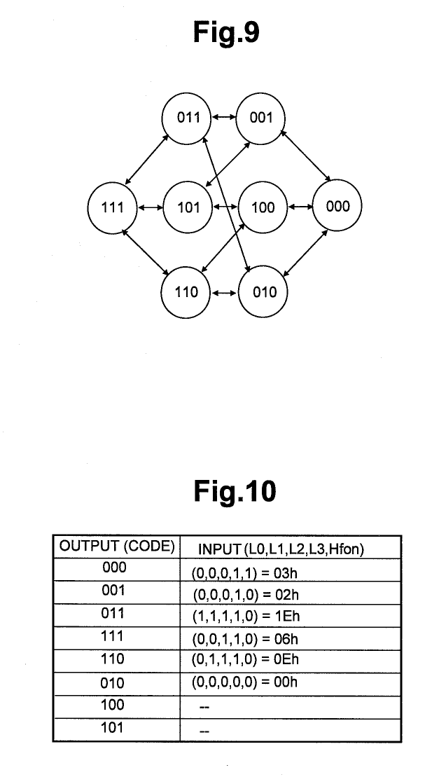

In the present embodiment, gray codes are used for encoding in the first embodiment. The gray codes are of code at which changes in bit at state transitions are respectively assumed to be 1 bit when respective code values are expressed as states. Their state transitions are shown in FIG. 9. As main pulse shapes possible at the recording strategy, there are several kinds such as a pulse train using a multipulse, a castle type pulse train, etc. Since a pulse-in change in power level is patterned at any of these, they can be applied to the state transitions based on the gray codes in FIG. 9. In the recording strategy of FIG. 2 shown in the first embodiment, for example, encoding is done like such encode outputs as shown in FIG. 8, thereby making it possible to transmit recording pulse information in the form of gray codes. A conversion table used in the encoding at this time is represented as shown in FIG. 10.

Reference numerals 801 through 803 respectively indicate encode output signal waveforms at the time that the gray codes are used. Since a change in state transition is always only one bit, i.e., one signal in the case of each gray code, change points of the respective encode output signal waveforms, i.e., edge timings do not overlap as shown in the figure. It is thus possible to solve the problem (c) described in the system of (1) in the conventional example, and the problems of management of phase and skew between bit signals.

### Third Embodiment

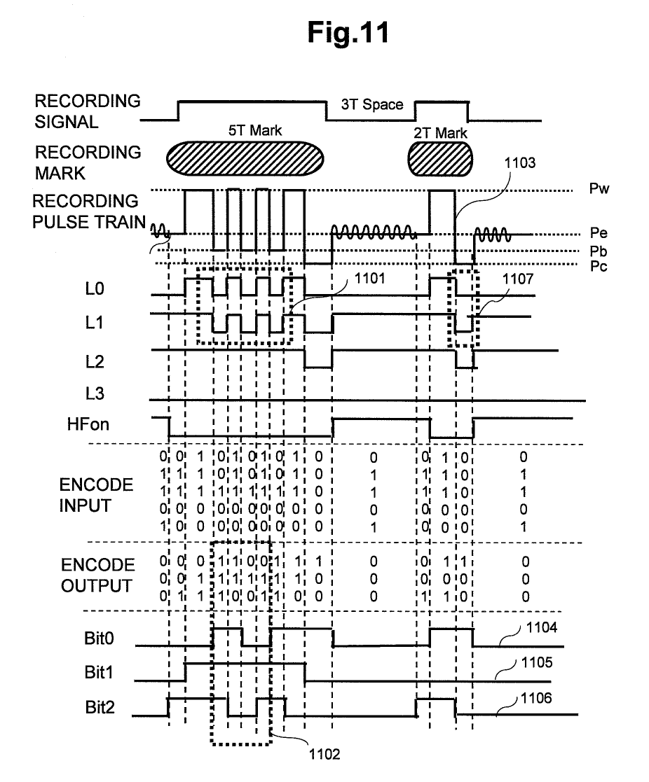

A diagram illustrative of the transmission of recording pulse information in a third embodiment of the present invention is shown in FIG. 11. The same figure is a diagram where pulse-timing transmission of a recording strategy containing a multipulse is performed by encoding based on the gray codes shown in the second embodiment. The shortest cycle of a multipulse at each of DVD and BD is a reference clock cycle 1Tw of a recording signal. Therefore, when the recording pulse information of the recording strategy containing the multipulse are transmitted, the method of the conventional example (1) needs to transmit short pulses each not greater than a channel clock 1Tw at L0 and L1 as shown inside a broken line 1101 of FIG. 11. Since, however, a flexible cable or the like used as a transmission path or line for L0 to L3 or the like has a transmission band, it becomes difficult to transmit these short pulses with the speed of recording for an optical disk. In order to avoid it, a multipulse portion is configured by four states of gray codes as indicated by a broken line 1102. Thus, the shortest pulse widths of respective pulses of bits 0 to 2 for the gray codes can be set greater than or equal to 1Tw. Thus, providing a transition condition in such a manner that the immediately preceding state is not reached at the state transitions of the gray codes makes it possible to set the shortest pulse widths of the respective pulses 1104 to 1106 of bits 0 to 2 for the gray codes to twice or more the pulse time width of a recording pulse train 1103 and reduce the influence of the band in the above transmission path.

### Fourth Embodiment

When it is however considered that the transmission of the recording pulse information with the gray codes corresponding to eight states of 3 bits is performed as shown in FIG. 11, the transitions from the respective states are limited to three states as shown in FIG. 9. When it is provided with a transition condition in such a manner that the immediately preceding state is not reached at the state transitions of the gray codes as mentioned above, the allowable state transitions become two states. Further, when the same recording pulse information is adapted to another gray code with being assigned thereto as in the multipulse portion referred to above, for example, the transitions from Pw become two types of transitions to Pb and a transition to three states corresponding to a transition (portion designated at 1107 in FIG. 11) to Pc at a mono pulse. Thus, the state transition condition is not satisfied.

A fourth embodiment of the present invention that has coped with the above problem will be explained below. Let's consider in the present embodiment that the state transition is changed according to the number of times that a multipulse containing leading and end pulses is repeated. In the case of the recording strategy containing the multipulse shown in FIG. 11 by way of example, the state transition is changed according to the cases where the number of times that the multipulse is repeated is an even number of times, an odd number of times and once (mono pulse) as shown in FIG. 13. In the same figure, each state corresponds to each power level of the recording strategy. When the multipulse number is once (mono pulse), the state transition is set so as to trace a transition indicated by a thick line, when it is the even number of times, the state transition is set so as to trace a transition indicated by a thin line, and when it is the odd number of times, the state transition is set so as to trace a transition indicated by a dotted line. Thus, while all pulse time widths to be transmitted are being set to twice or more the pulse time width at a recording pulse train, 3-bit gray codes for the recording strategy of FIG. 11 can be transmitted. Further, a reduction in the influence of the band in the transmission path and reductions in the number of transmission signal lines and the number of LSI pins can be made compatible.

### Fifth Embodiment

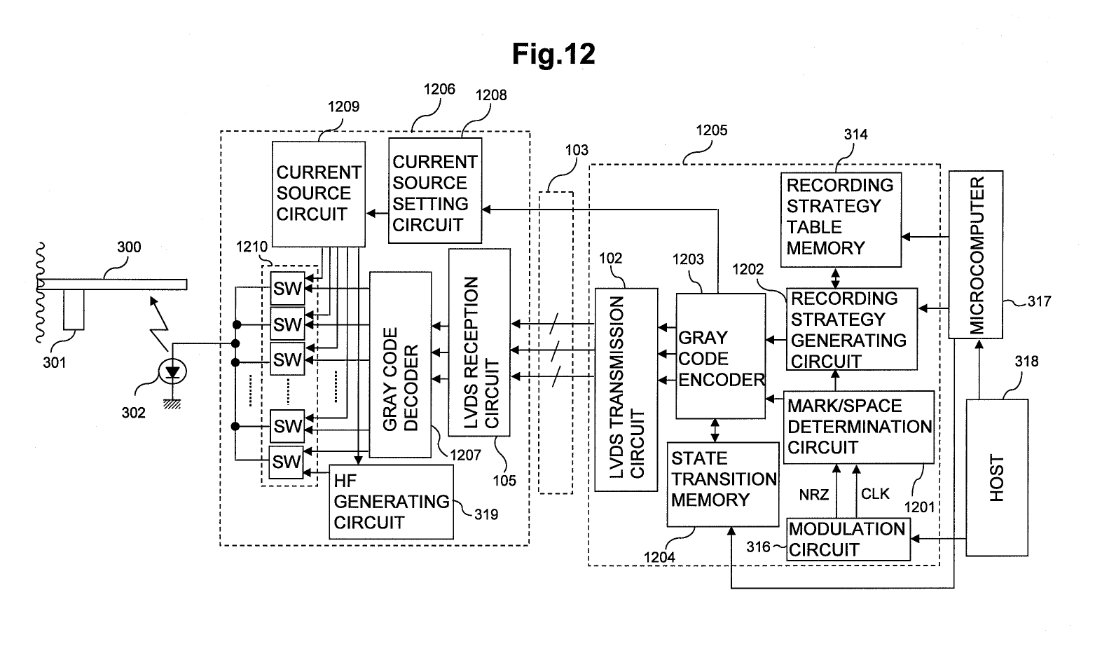

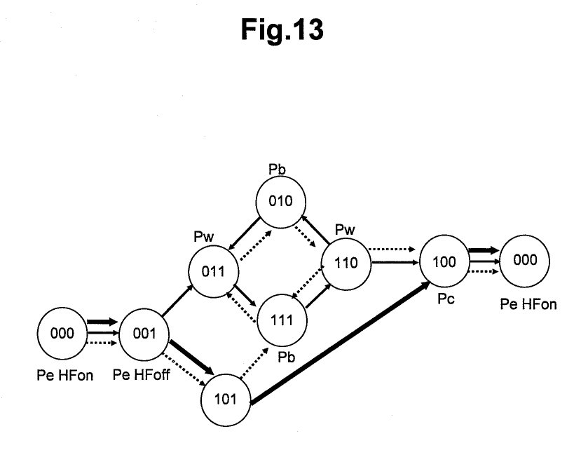

A configuration diagram of blocks related to an information recording operation of an optical disk apparatus according to a fifth embodiment of the present invention is shown in FIG. 12. In the same figure, similar figure numbers are respectively attached to the blocks having functions similar to those shown in FIG. 1, and their explanations are omitted.

In a manner similar to the first embodiment, record data from an upper-level host 318 is inputted to the inside of a signal processing LSI 1205 and modulated by a modulation circuit 316, from which NRZ and CLK are outputted. They are inputted to a mark/space determination circuit 1201, where their mark and space lengths are determined.

The result of determination by the same block is transmitted to a recording strategy generating circuit 1202 and a gray code encoder 1203. The recording strategy generating circuit 1202 selects recording strategy information from a recording strategy table memory, based on marks, space information and medium information to generate pulse timing information. The pulse timing information is transmitted to the gray code encoder 1203 where it is converted to gray codes. A state transition of each gray code used for conversion of pulse train information is selected from a state transition memory 1204. The state transition is selected using the result of determination by the mark/space determination circuit. Each state transition stored in the state transition memory is registered programmably from the microcomputer 318 by firmware or the like that performs control of the optical disk apparatus. The gray codes converted from the pulse timing information along the selected state transition are converted to LVDS by an LVDS transmission circuit 102, followed by each being inputted to an LVDS reception circuit 105 of a laser driver via a transmission path 103 such as a flexible cable. The received gray codes are converted by a gray code decoder 1207.

On the other hand, power level information of each recording strategy generated at the strategy generating circuit lying inside the signal processing LSI 1205 is converted to power level information corresponding to each gray code via the gray code encoder 1203, which in turn is outputted to a current source setting circuit 1208 of the laser driver 1206. The current source setting circuit 1208 sets a current value corresponding to each power level to a current source 1209 corresponding to each gray code of the current source circuit 1209. As a method for setting power levels, there is considered, for example, a technique such a method for setting a current source selection by address information and setting each current value with a digital value with the current source circuit 1209 as a DAC (Digital Analog Converter). The respective outputs of the current source circuit 1209 are outputted to a switch group 1210 corresponding to the respective gray codes. The switch group 1210 is configured in such a manner that the currents corresponding to the gray codes and the gray code values decoded by the gray code decoder 1207 are associated with each other at 1:1. Thus, the current value corresponding to the gray code value is selected by the switch group 1210 and outputted to a laser 302. The pulse timing transmission according to the fourth embodiment can be realized owing to the present configuration.

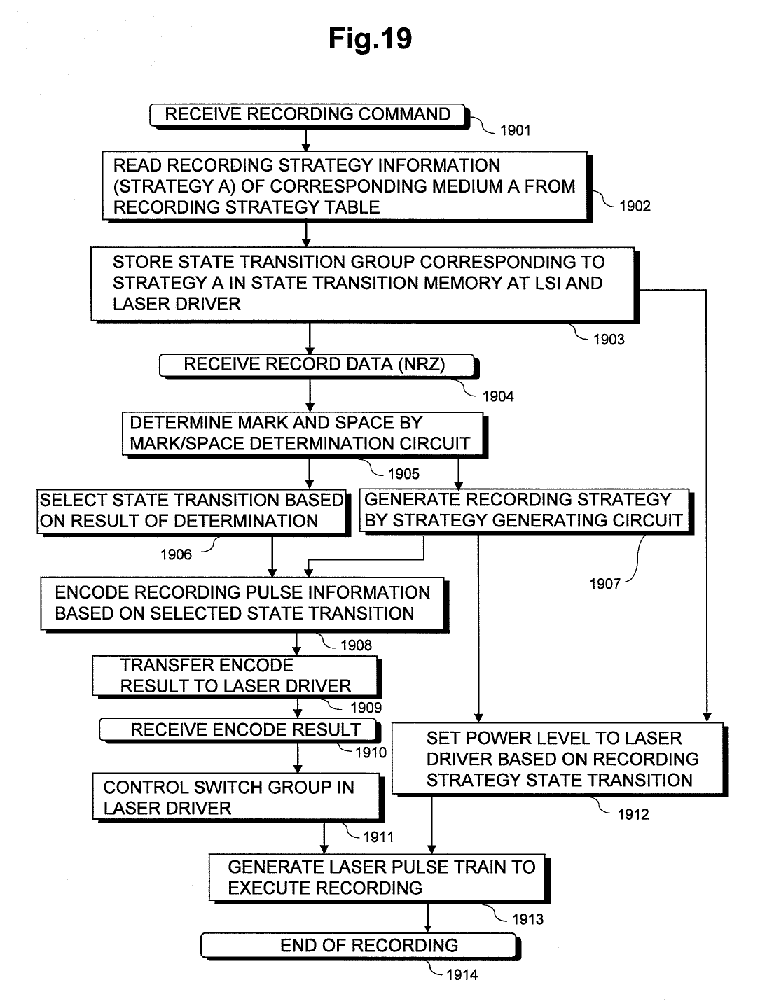

A flowchart showing the operation of recording information onto an optical disk in the present embodiment is shown in FIG. 19. When a recording command and record data are received from the upper-level host (1901), recording strategy information (defined as “strategy A”) on the corresponding disk is read out from a recording strategy table (1902). Next, a state transition group corresponding to the strategy A is stored in its corresponding state transition memory mounted onto each of the signal processing LSI and the laser driver (1903). The state transition group is of a group in which state transitions different according to marks and space of NRZ are collected up with respect to the same recording strategy. The state transition group is registered programmably from the microcomputer to the state transition memory by firmware or the like that performs control of the optical disk. Next, NRZ of the record data is inputted from the modulation circuit to the mark/space determination circuit (1904). The result of determination by the mark/space determination circuit is sent to the strategy generating circuit and the gray code encoder (1905). The strategy generating circuit generates recording pulse information and power level information from the result of determination (1907). The gray code encoder encodes the recording pulse information to gray codes, based on the state transition (1906) selected from the recording pulse information and mark/space determination result outputted from the strategy generating circuit (1908). The result of encoding is transmitted to the laser driver (1909) to control the switch group provided thereinside (1911). On the other hand, the power level information generated at the strategy generating circuit is set to the current source setting circuit of the laser driver, based on the state transition group (1912). A laser pulse train is outputted from the switch control and current outputs generated by the current source setting circuit to execute recording (1913 and 1914).

In the present system, the state transitions registered in the state transition memory 1204 lying inside the signal processing LSI 1205 and the correspondence of the gray codes and power levels set to the current source setting circuit 1208 lying inside the laser driver 1206 are changed, thereby making it possible to realize encoding to each gray code based on a state transition relative to an arbitrary recording strategy.

Incidentally, when the encoding of the third embodiment is adopted, the fifth embodiment makes it possible to cause the pulse time width of each gray code transmitted between the signal processing LSI and the laser driver to have a margin with respect to the transmission characteristic of the transmission path such as the flexible cable. Therefore, it is also considered that the LVDS transmission circuit 102 and the LVDS reception circuit 105 shown in FIG. 12 are omitted and each gray code is transmitted as a normal binarized signal.

In a manner similar to the third embodiment even in the second embodiment, the shortest pulse can be set to twice or more the pulse time width in the recording pulse train in a manner similar to the above by selection of the gray code conversion table, depending on the design of the recording strategy. In such a case, it is also considered that the blocks 102 and 105 related to the transmission/reception of LVDS shown in FIG. 1 are omitted and each gray code is transmitted between the signal processing LSI and the laser driver as a normal binarized signal.

Although the setting by the addresses and DAC values has been described upon the setting of the power levels to the laser driver in the fifth embodiment, it is needless to say that since the power level setting is similar even in the first through third embodiments, the above setting method and the control configuration of the current source circuit can be applied even to the first through third embodiments.

### Sixth Embodiment

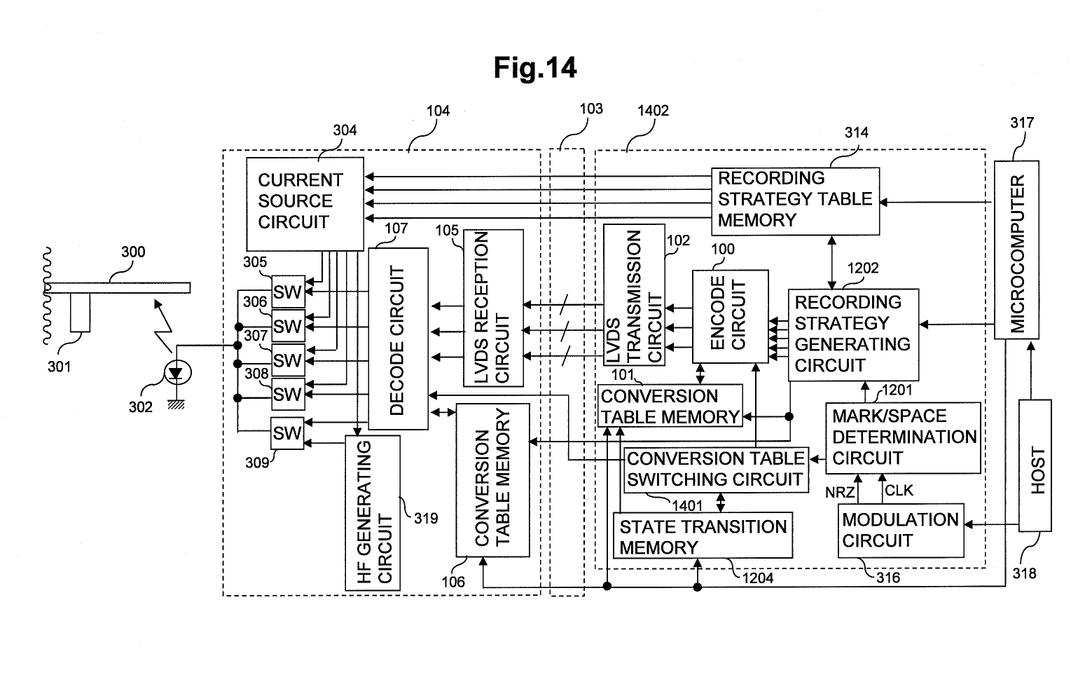

A configuration diagram of blocks related to an information recording operation of an optical disk apparatus according to a sixth embodiment of the present invention is shown in FIG. 14. In the same figure, similar figure numbers are respectively attached to the blocks having functions similar to those shown in FIGS. 1 and 12, and their explanations are omitted.

FIG. 14 is different from FIGS. 1 and 12 in that a conversion table switching or selecting circuit 1401 has been added. The conversion table switching circuit switches conversion tables used in an encode circuit 100 and a decode circuit 107 according to mark/space information outputted from a mark/space determination circuit 1201. The conversion table to be used is selected according to mark lengths and the number of times for a multipulse or the like, based on the state transition diagram 1204 for the gray code conversion and the like shown in the fourth embodiment, for example.

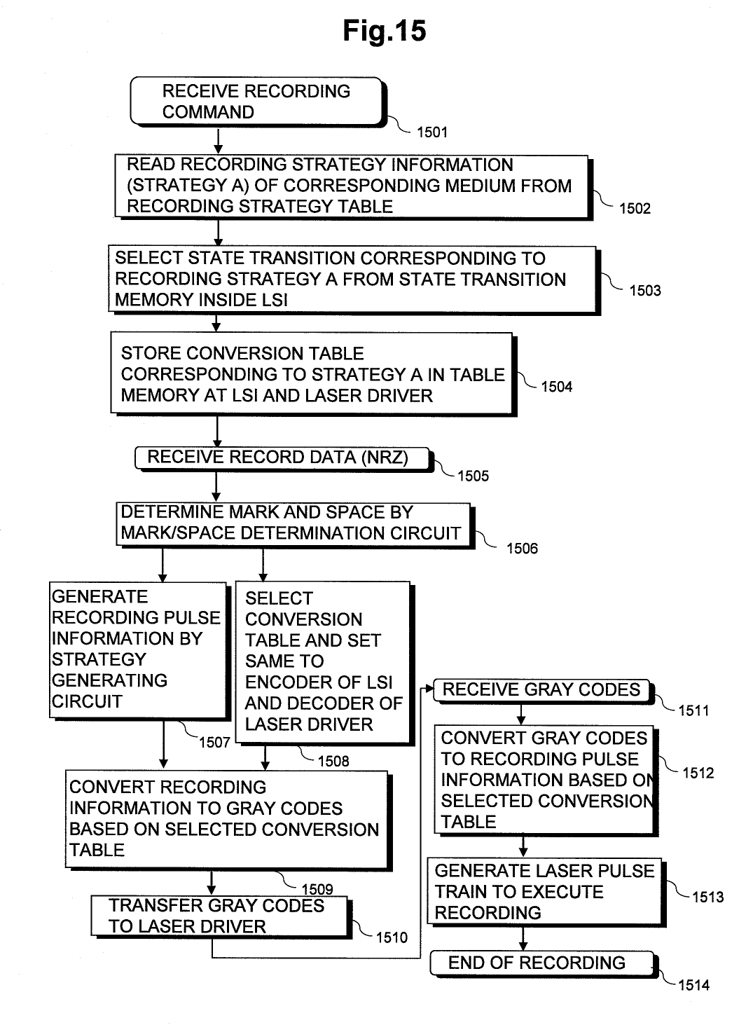

A flowchart showing the operation of recording information onto an optical disk in the present embodiment is shown in FIG. 15. When a recording command and record data are received from an upper-level host (1501), recording strategy information (defined as “strategy A”) on the corresponding disk is read out from a recording strategy table (1502). Next, a state transition corresponding to the strategy A is selected from its corresponding state transition memory for performing gray code conversion (1503). A conversion table corresponding to each mark and space length in the state transition is set to its corresponding conversion table memory mounted onto each of a signal processing LSI and a laser driver (1504). Each state transition registered in the state transition memory and each conversion table on the conversion table memory of each of the signal processing LSI and the laser driver can be set programmably from a microcomputer by firmware or the like that performs control of the optical disk apparatus. Next, NRZ of the record data is inputted from a modulation circuit to the mark/space determination circuit (1505). The result of determination thereby is sent to the corresponding strategy generating circuit and conversion table selecting circuit (1506). The strategy generating circuit generates recording pulse information from the result of determination (1507). The conversion table selecting circuit selects a conversion table used for gray code conversion from the result of determination and sets it to each of the encode circuit lying inside the signal processing LSI and the decode circuit of the laser driver (1508). Next, the encode circuit performs the conversion of the recording pulse information by the selected conversion table to generate gray codes (1509), which in turn are transmitted to the laser driver (1510). The laser driver performs the conversion of each received gray code by the selected conversion table to generate recording pulse information (1512), after which a laser pulse train is outputted to execute recording (1513 and 1514).

The present embodiment can obtain advantageous effects similar to the fourth embodiment by the laser driver configuration close to the recording pulse information transmission configuration of the system of the conventional example (1). It is thus possible to suppress an increase in the scale of the laser driver circuit due to the addition of a current source setting circuit and a switch group. Further, an increase in power consumption can be suppressed with the suppression of the increase in circuit scale, and degradation of recording performance due to heat generation by the laser driver on its corresponding pickup can be suppressed.

### Seventh Embodiment

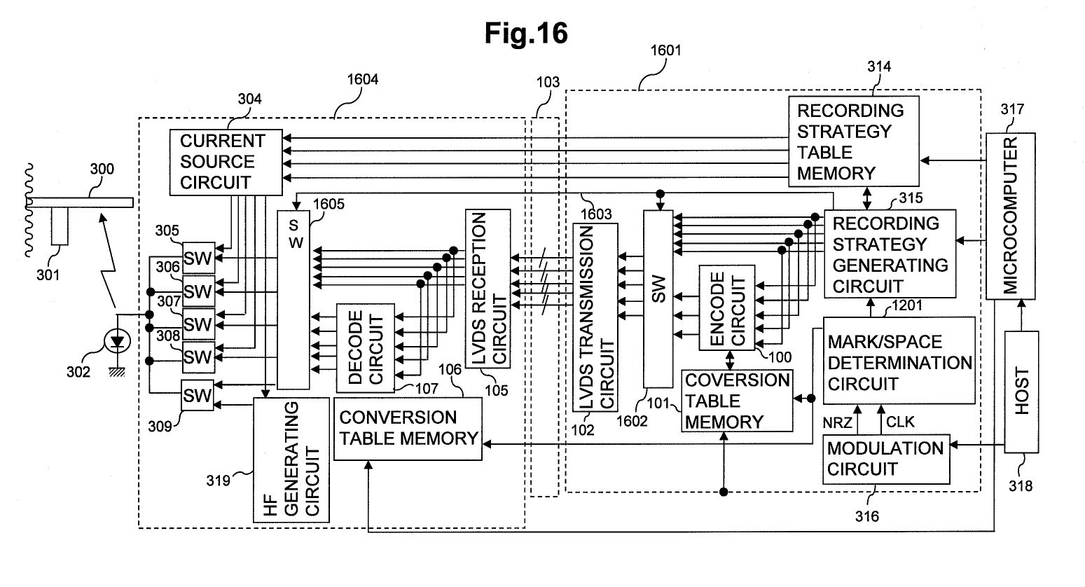

A configuration diagram of blocks related to an information recording operation of an optical disk apparatus according to a seventh embodiment of the present invention is shown in FIG. 16. In the same figure, similar figure numbers are respectively attached to the blocks having functions similar to those shown in FIG. 1, and their explanations are omitted.

FIG. 16 differs from FIG. 1 in that changeover or selector switches 1602 and 1605 controlled based on a control signal 1603 by means of a recording strategy generating circuit are respectively provided inside a signal processing LSI 1601 and a laser driver 1604. The switch 1602 switches the pulses L0 through L3 and Hfon shown in FIG. 8 in the second embodiment, which are outputted from a recording strategy generating circuit 315 and pulses Bit0 through Bit2 corresponding to encode results outputted from an encode circuit 100 and outputs the same to an LVDS transmission circuit 102. Since, at this time, the number of the pulses outputted from the switch 1602 is five in association with L0 through L3 and Hfon, whereas the number of the pulses outputted from the encode circuit 100 is three, two LVDS transmission paths or lines are not used upon selection of each output of the encode circuit 100 by the switch 1602. As to the transmission paths of LVDS at the selection of the encode circuit, for example, the five LVDS transmission paths or lines are selected alternately, so that leakage of each signal between the transmission paths can also be reduced. The switch 1605 performs switching between the outputs of an LVDS reception circuit 105 and the outputs from the decode circuit 107 and outputs the same to subsequent-stage switches 305 through 309. When the switches 1602 and 1605 are set in conjunction with each other and the switch 1602 selects the pulses L0 through L3 and Hfon, the corresponding outputs of the LVDS reception circuit 105 are selected by the switch 1605. Similarly when the pulses Bit0 through Bit2 are selected by the switch 1602, the corresponding outputs of the decode circuit 107 are selected by the switch 1605.

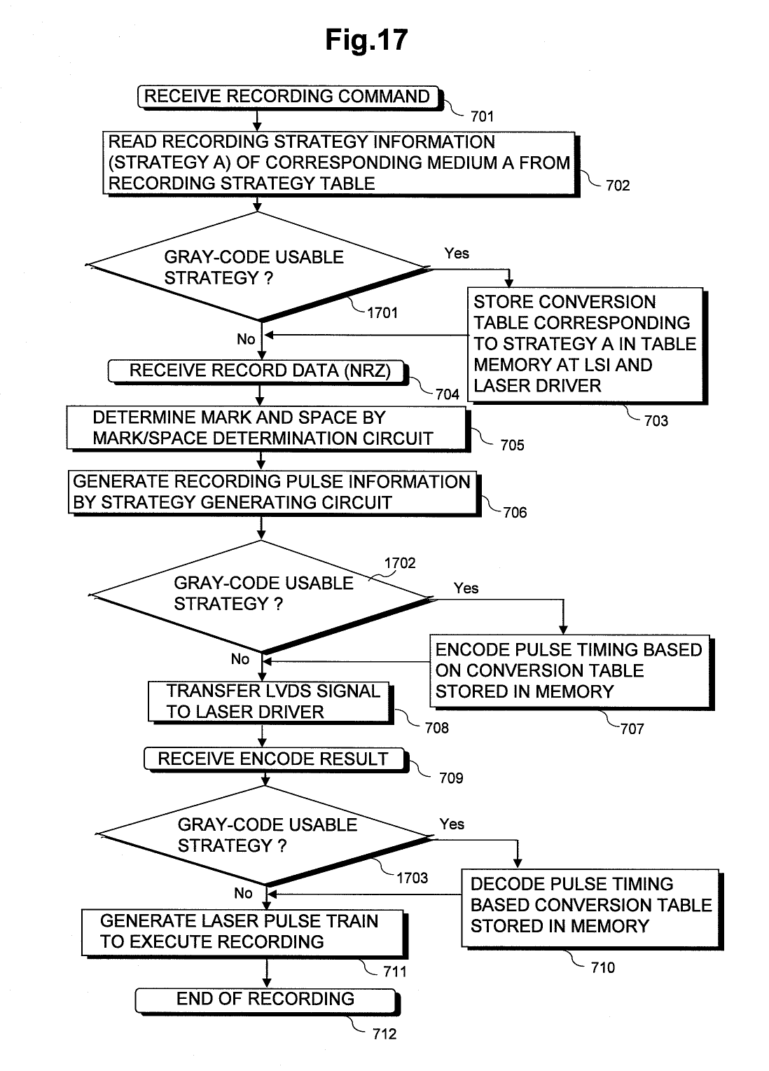

A flowchart showing the operation of recording information onto the optical disk in the present embodiment is shown in FIG. 17. In the present figure, the same figure numbers are respectively attached to the same processes as those in FIG. 7 showing the operation flow in the first embodiment.

When a recording command and record data are received from an upper-level host (701), recording strategy information (defined as “strategy A”) of the disk is read from the corresponding recording strategy table (702). Here, it is determined whether the read strategy A is of a gray-code usable strategy (1701). Criteria as to whether each gray code is usable, are made according to the following examples:

1. whether all pulse time widths used to transmit gray codes according to state transitions can be set to twice or more each pulse time width in a recording pulse train,
2. whether the combinations of the number of power levels, change timings and the like can be encoded within the number of bits of the encode circuit, and
3. whether a recording double speed is greater than or equal to a predetermined speed.

When it is determined at the criterion 1701 that the gray codes can be used, a conversion table corresponding to the strategy A is set to its corresponding conversion table mounted to each of the signal processing LSI and laser driver (703). The conversion table is set programmably from a microcomputer by firmware or the like that performs control of the optical disk apparatus. When it is determined at the criterion 1701 that the gray codes cannot be used, no processing for the conversion table is done. Next, NRZ of record data is inputted from a modulation circuit to a mark/space determination circuit (704). The result of determination thereby is inputted to the strategy generating circuit (705), and recoding pulse information is generated (706). Here, it is determined in a manner similar to the criterion 1701 whether the strategy A is of a gray-code usable strategy (1702). When it is found to be usable, each recording pulse information is encoded at the encode circuit of the signal processing LSI, based on the set conversion table (707), which in turn is transmitted to the laser driver (708). When the gray codes are not usable, each recording pulse information is transmitted to the laser driver through the LVDS transmission circuit as it is. When the result of encoding (709) is received, the laser driver determines whether the used recording strategy A is of the gray-code usable strategy (1703). When it is found to be usable, it is converted based on the set conversion table to generate recording pulse information (710), and a laser pulse train is outputted to execute recording (711 and 712). When it is found not to be usable, a laser pulse train is outputted using the so-obtained recording pulse information to execute recording. Incidentally, since the determining processes 1702 and 1703 are the same result as the criterion 1703, the result of the criterion 1701 may be used as it is.

With the above processing, the recording pulse information are directly transmitted where the recording strategy is complex and encoding with the limited number of bits is difficult, whereas when, for example, the recording speed is made fast and the transmission of each short pulse is difficult and when the influence of recording strategy degradation due to a shift in phase between pulses is large, switching such as encoding of recording pulse information to the gray codes or the like and the transmission thereof is enabled. A best improvement in the degree of freedom of design of the recording strategy with respect to each of the first through fifth embodiments, and the setting of recording strategy optimized according to the conditions such as the recording speed and the like can be performed.

### Eighth Embodiment

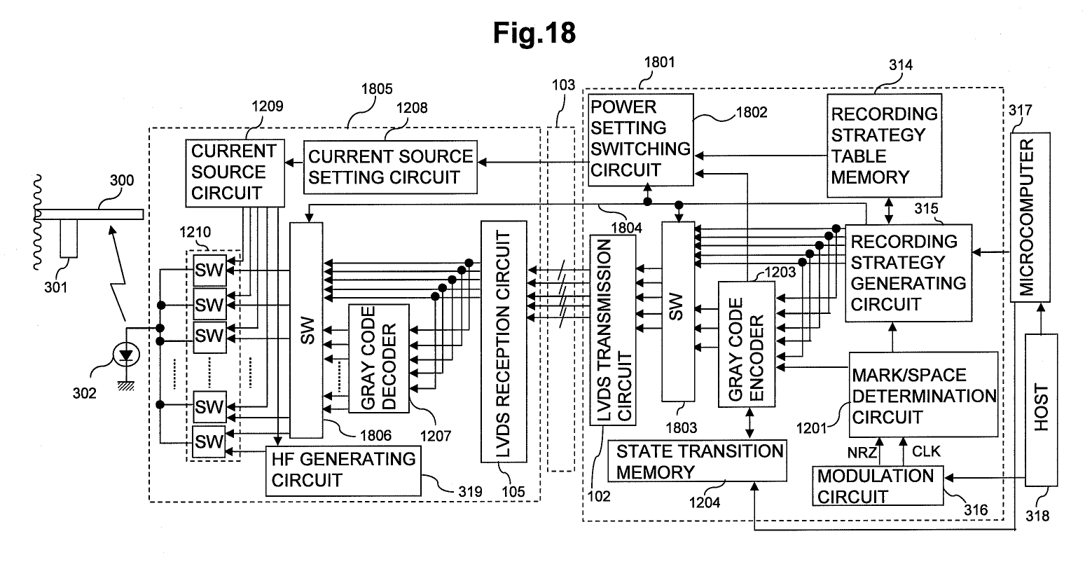

A configuration diagram of blocks related to an information recording operation of an optical disk apparatus according to an eighth embodiment of the present invention is shown in FIG. 18. In the same figure, similar figure numbers are respectively attached to the blocks having functions similar to those in FIG. 12, and their explanations are omitted.

FIG. 18 differs from FIG. 12 in that selector switches 1803 and 1806 controlled based on a control signal 1804 by a recording strategy generating circuit are respectively provided inside a signal processing LSI 1801 and inside a laser driver 1805, and a power setting switching circuit 1802 controlled by the control signal 1804 is provided inside the signal processing LSI 1801. In a manner similar to the seventh embodiment, the selector switches 1803 and 1806 are switches each of which switches such that a signal transmitted between the signal processing LSI and the laser driver is set to either recording pulse information or each gray code. The power setting switching circuit 1802 switches the setting of a current source setting circuit 1208 lying inside the laser driver in conjunction with the switching of the transmitted signal. When the signal transmitted between the signal processing LSI and the laser driver is taken as the recording pulse information, the current source setting circuit 1209 sets power levels corresponding to respective pulses. When the signal transmitted between the signal processing LSI and the laser driver is taken as each gray code, the power levels corresponding to the states of the gray codes are set to the current source setting circuit 1209 as illustrated in FIG. 13. Incidentally, while the number of power levels where the gray codes are used, is represented in the form of eight values of 3 bits in the example of FIG. 13, the power levels where the recording pulse information are used become five values of L0 through L3 and Hfon in the fourth embodiment, for example. Therefore, if, for example, an unused current source circuit is set to a current output of zero and the operation of each unused switch is fixed, where the use of the recording pulse information is selected, it is then possible to suppress power consumption at the laser driver.

Owing to the present embodiment, the transmission of the recording pulse information and the transmission of the result of encoding by the gray codes can be used by switching even when the recording pulse information are converted to the gray codes using state transitions, followed by transmission thereof, thus making it possible to obtain advantageous effects similar to those in the seventh embodiment.

Incidentally, although the current output portions are shown as such configurations as to select the switches in the laser driver in the embodiment of the present invention, there is also considered in addition to the above, for example, such a configuration that the current source circuit is taken as a DAC circuit and its DAC value is changed over based on each gray code. This is not limited to the embodiment of the present invention.

Although the control of each switch is done from the recording strategy generating circuit in each of the seventh and eighth embodiments, there is also considered that it is controlled programmably through a microcomputer or the like by firmware or the like that performs control of the optical disk apparatus.

Although the switching of the conversion memory table is controlled based on the output of the mark/space determination circuit in each of the first and seventh embodiments of the present invention, there is also considered that it is controlled programmably through the microcomputer or the like by means of the firmware or the like that performs the control of the optical disk apparatus. Similarly, although the conversion table switching circuit is controlled by the output of the mark/space determination circuit in the sixth embodiment, there is also considered that it is controlled programmably through the microcomputer or the like by means of the firmware or the like that performs the control of the optical disk apparatus. Similarly, although the selection of each state transition by the gray code encoder is controlled by the output of the mark/space determination circuit in the second through fifth and eighth embodiments, there is also considered that it is controlled programmably through the microcomputer or the like by means of the firmware or the like that performs the control of the optical disk apparatus.

### Ninth Embodiment

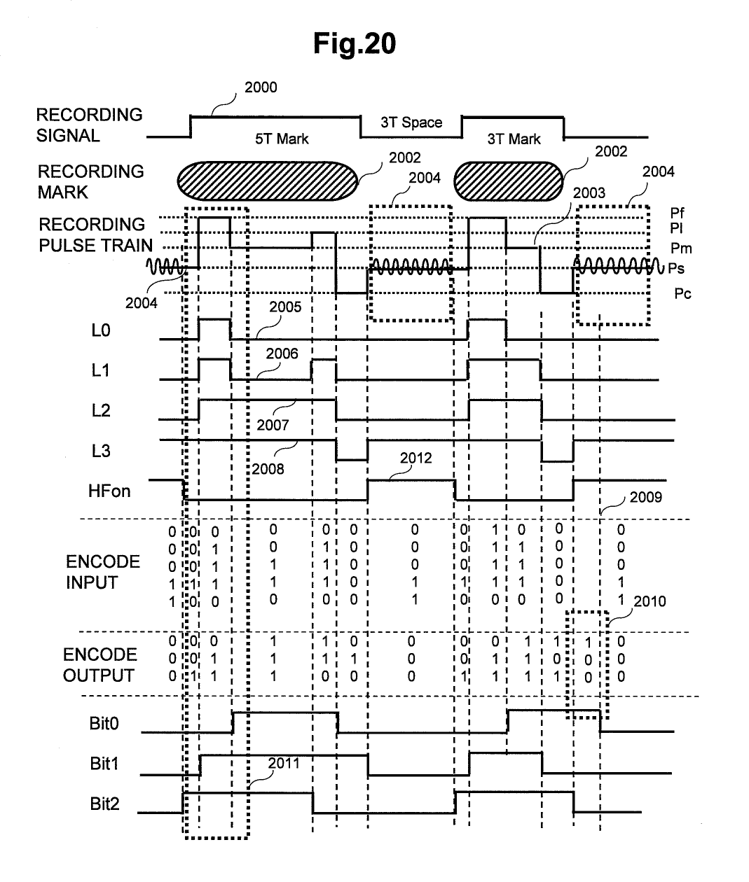

A diagram of the transmission recording pulse information in a ninth embodiment of the present invention is shown in FIG. 20. While the present figure is of a castle type strategy in a manner similar to FIG. 8, it differs from FIG. 8 in terms of a recording pulse waveform of each 3T mark.

When recording pulse information on L0 through L3 and Hfon are converted to gray codes and they are transmitted, as described in the second embodiment, pulse power values containing on/off of an HF output, and gray codes are transmitted in a one-to-one correspondence. This results in the transmission that the on and off of HF are also taken as edges of changes in pulse power and gray codes are caused to change at edge points of recording pulses, i.e., a state transition is carried out. Since the pulse power values and the gray codes are associated with one another at 1:1 in this way, it is necessary to output the same gray code at a space portion (corresponding to a state in which HF is rendered on in this case) designated at numeral 2004 of the figure.

On the other hand, when a state change is done from a given state at each gray code and the original state is reached, as apparent from the state transition diagram of the gray codes shown in FIG. 9, it is an essential condition that the number of state transitions in this case is an even number of times. When, however, the space portion described above is returned to the original space portion via a 3T recording pulse, the number of pulse edges thereof (containing on/off of HF) is five times. Therefore, when a 3T mark is generated, a problem arises in that the state transition of each gray code is not restored to the original condition.

In order to avoid it, a gray code state transition based on a dummy edge is generated. The dummy edge corresponds to 2009 in FIG. 20. At this portion, no change in pulse power occurs in a recording pulse train 2003. However, the state of each gray code is caused to change at the dummy edge portion as designated at numeral 2010 in the figure, thereby making it possible to set the number of state transitions of gray codes that has been an odd number of times at the 3T mark, to an even number of times, whereby the state transition can be restored to the original gray code state at the space portion.

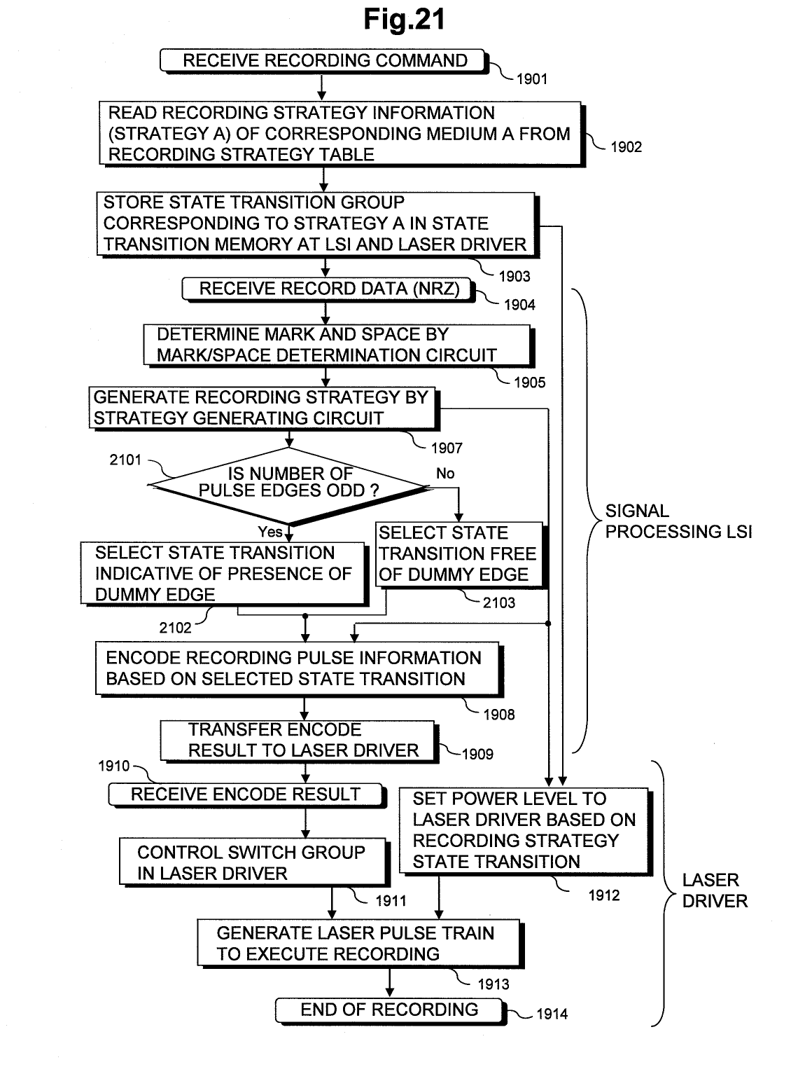

A flowchart showing the operation of recording information on an optical disk in the present embodiment is shown in FIG. 21. In the present figure, the same figure numbers are respectively attached to the same processes as those in FIG. 19 showing the operation flow in the fifth embodiment.

The present embodiment is similar to the fifth embodiment from the reception (1901) of a recording command and record data from an upper-level host to the process of the input (1904) of NRZ of record data outputted from a modulation circuit to a mark/space determination circuit. While each of the state transitions of the gray codes is selected from the above result of mark/space determination in the fifth embodiment, a recording strategy is generated from the above result of mark/space determination (1906) and the number of pulse edges at the recording strategy is also added to a state transition selection condition (2101) in addition to the above in the present embodiment. When the number of the pulse edges is odd, a state transition indicative of the presence of a dummy edge is selected (2102). When the number thereof is even, a state transition free of each dummy edge is selected (2103). Processes subsequent to the above are similar to those in the fifth embodiment, and their explanations are omitted herein. Changing each of the state transitions of gray codes encoded according to the number of pulse edges in this way makes it possible to realize the state transition restored to the original state regardless of the recording mark lengths as mentioned above.

Thus, the change of state of each gray code is suitably generated at each portion where the power level of each recording pulse does not change, thereby making it possible to bring the change of state of the gray code at each mark to an even number of times at all times. It is thus possible to assign the power levels of the recording pulses to the gray codes efficiently while the state number of the gray codes is being minimized.

Incidentally, as the timings to generate the dummy edges described above, various timings are considered as follows:

1. A timing to generate a dummy edge after a predetermined time from the immediately preceding pulse edge,
2. A timing to generate a dummy edge after a predetermined time from the falling edge (mark end edge) of a recording signal (2000 in FIG. 20),
3. A timing to generate a dummy edge before a predetermined time from the rising edge (mark start edge) of the recording signal (2000 in FIG. 20),
4. A timing to generate a dummy edge in sync with a predetermined edge (after a predetermined clock cycle from the falling edge of the recording signal, for example) of a recording clock synchronized with the recording signal, and
5. A timing to generate a dummy edge at a predetermined position (an intermediate position or the like of a top pulse 2011 in FIG. 20, for example) lying inside a recording strategy. Even in any case, the dummy edges may be generated at their corresponding temporally-shifted positions enough to generate pulse edges of gray code pulses (Bit0 through Bit2 in FIG. 20) with respect to the edge positions of the recording pulses at which the state transitions of the gray codes occur.

What is claimed is:

1. An optical disk apparatus which records information in a recording medium using a pulse train based on laser emission, comprising:
a mark/space length discrimination circuit for discriminating mark and space lengths lying over the recording medium from the information recorded in the recording medium;
a laser pulse train generating circuit for determining a shape of a laser pulse train from the output of the mark/space length discrimination circuit;
a change timing signal generating circuit for outputting a plurality of change timing signals each based on a binary pulse train, indicative of change timings each corresponding to an amount of light emitted by a laser on the basis of the laser pulse train outputted from the laser pulse train generating circuit;
an encode circuit for converting the change timing signals to code signals respectively, based on a predetermined conversion table and outputting each of the signals to a signal transmission path;
a decode circuit for converting the code signals each inputted via the signal transmission path to a plurality of change timing signals each corresponding to an amount of light emitted by the laser respectively, based on a predetermined conversion table; and
a laser drive circuit for generating a laser drive current for forming a laser pulse train, based on the change timing signals outputted from the decode circuit.

2. The optical disk apparatus according to claim 1, further including:
a first switch circuit for outputting to the signal transmission path by switching the change timing signals outputted from the change timing signal generating circuit and the code signals outputted from the encode circuit; and
a second switch circuit for outputting by switching the change timing signals transmitted from the change timing signal generating circuit via the transmission path and the change timing signals outputted from the decode circuit.

3. The optical disk apparatus according to claim 2,
wherein when the shape of the laser pulse train generated by the laser pulse train generating circuit is of a predetermined shape, a selection for outputting each code signal outputted from the encode circuit to the signal transmission path at the first switch circuit, an encode process at the encode circuit, a decode process at the decode circuit, and a selection for outputting the change timing signals outputted from the decode circuit to the laser drive circuit at the second switch circuit are executed, and
wherein when other than the above, a selection for outputting each of the change timing signals outputted from the change timing signal generating circuit to the signal transmission path at the first switch circuit, and a selection for outputting the change timing signals outputted from the change timing signal generating circuit to the laser drive circuit at the second switch circuit are executed.

4. The optical disk apparatus according to claim 2,
wherein when the number of power levels of the laser pulse train generated by the laser pulse train generating circuit is less than or equal to a predetermined value, a selection for outputting each of the code signals outputted from the encode circuit to the signal transmission path at the first switch circuit, an encode process at the encode circuit, a decode process at the decode circuit, and a selection for outputting the change timing signals outputted from the decode circuit to the laser drive circuit at the second switch circuit are executed, and
wherein when other than the above, a selection for outputting each of the change timing signals outputted from the change timing signal generating circuit to the signal transmission path at the first switch circuit, and a selection for outputting the change timing signals outputted from the change timing signal generating circuit to the laser drive circuit at the second switch circuit are executed.

5. The optical disk apparatus according to claim 2,
wherein when a recording clock cycle synchronized with record data recorded in the recording medium is less than or equal to a predetermined value, a selection for outputting each code signal outputted from the encode circuit to the signal transmission path at the first switch circuit, an encode process at the encode circuit, a decode process at the decode circuit, and a selection for outputting the change timing signals outputted from the decode circuit to the laser drive circuit at the second switch circuit are executed, and
wherein when other than the above, a selection for outputting each of the change timing signals outputted from the change timing signal generating circuit to the signal transmission path at the first switch circuit, and a selection for outputting the change timing signals outputted from the change timing signal generating circuit to the laser drive circuit at the second switch circuit are executed.

6. The optical disk apparatus according to claim 2,
wherein when the number of different amounts of light emitted by the laser in the laser pulse train generated by the laser pulse train generating circuit is less than or equal to the number of combinations expressed in the predetermined codes, a selection for outputting each of the code signals outputted from the encode circuit to the signal transmission path at the first switch circuit, an encode process at the encode circuit, a decode process at the decode circuit, and a selection for outputting the change timing signals outputted from the decode circuit to the laser drive circuit at the second switch circuit are executed, and
wherein when other than the above, a selection for outputting each of the change timing signals outputted from the change timing signal generating circuit to the signal transmission path at the first switch circuit, and a selection for outputting the change timing signals outputted from the change timing signal generating circuit to the laser drive circuit at the second switch circuit are executed.

7. The optical disk apparatus according to claim 1,
wherein either one or both of conversion tables used for conversion of the change timing signals and the code signals at the encode circuit, and conversion tables used for conversion of the code signals and the change timing signals at the decode circuit are changed based on the shape of the laser pulse train generated by the laser pulse train generating circuit.

8. The optical disk apparatus according to claim 1, further including a state transition circuit for performing each of state transitions based on the laser pulse train generated by the laser pulse train generating circuit and thereby outputting states,
wherein either one or both of conversion tables used for conversion of the change timing signals and the code signals at the encode circuit, and conversion tables used for conversion of the code signals and the change timing signals at the decode circuit are changed based on the state outputs of the state transition circuit.

9. The optical disk apparatus according to claim 1,
wherein each of the code signals is assumed to be a multi-valued signal comprised of a multibit of 2 bits or more, and
wherein a continuous change in the multi-valued signal consists of 1 bit change.

10. An information recording method for recording information in a recording medium using a pulse train based on laser emission, comprising:
discriminating mark and space lengths lying over the recording medium from the information recorded in the recording medium;
determining a shape of a laser pulse train from the result of discrimination;
generating a plurality of change timing signals based on binary pulse trains, indicative of change timings each corresponding to an amount of light emitted by a laser on the basis of the laser pulse train;
generating code signals at which the change timing signals are respectively assigned to codes, based on a predetermined conversion table;
generating a plurality of change timing signals each corresponding to an amount of light emitted by the laser from the code signals, based on a predetermined conversion table; and
generating a laser drive current for forming a laser pulse train, based on the change timing signals generated from the code signals.

11. The information recording method according to claim 10,
wherein information recording is performed by switching a first laser emission control method and a second laser emission control method,
the first laser emission control method generating a laser drive current for forming a laser pulse train, based on the change timing signals based on the binary pulse trains to cause a laser to emit laser light, and
the second laser emission control method generating code signals at which the change timing signals based on the binary pulse trains are respectively assigned to codes, based on a predetermined conversion table, generating a plurality of change timing signals each corresponding to an amount of light emitted by the laser from the code signals, based on a predetermined conversion table, and generating a laser drive current for forming a laser pulse train, based on the change timing signals generated from the code signals to cause the laser to emit laser light.

12. The information recording method according to claim 10,
wherein information recording is done by performing switching between the first laser emission control method and the second laser emission control method, based on the number of power levels in the laser pulse train decided from the information recorded in the recording medium.

13. The information recording method according to claim 10,
wherein information recording is carried out by selecting the first laser emission control method when a time interval between the change timings for the amount of light emitted by the laser in the laser pulse train decided from the information recorded in the recording medium is greater than or equal to a predetermined value, and selecting the second laser emission control method when other than the above.

14. The information recording method according to claim 10,
wherein information recoding is done by selecting the first laser emission control method when the number of different amounts of light emitted by the laser in the laser pulse train generated by the laser pulse train generating circuit is greater than or equal to the number of combinations expressed in the predetermined codes, and selecting the second laser emission control method when other than the above.

15. The information recording method according to claim 10,
wherein either one or both of conversion tables used upon generating the code signals from the change timing signals, and conversion tables used upon generating a plurality of change timing signals each corresponding to an amount of light emitted by a laser from the code signals are changed based on the shape of the laser pulse train decided from the information recorded in the recording medium.

16. The information recording method according to claim 10,
wherein a plurality of state transitions are stored in advance in state transition storing means for storing state transitions therein, and
wherein either one or both of conversion tables used upon generating the code signals from the change timing signals, and conversion tables used upon generating a plurality of change timing signals each corresponding to an amount of light emitted by the laser from the code signals are changed based on the state transitions stored in the state transition storing means.

17. The information recording method according to claim 10,
wherein any one or more or all of conversion tables used upon generating code signals from the change timing signals, conversion tables used upon generating a plurality of change timing signals each corresponding to an amount of light emitted by the laser from the code signals, and state transition operations or the state transitions stored in the state transition storing means are changed programmably from control means such as a microcomputer or the like.

18. The information recording method according to claim 10,
wherein each of the code signals is assumed to be a multi-valued signal comprised of a multibit of 2 bits or more, and
wherein a continuous change in the multi-valued signal consists of 1 bit change.

19. A signal processing LSI comprising:
a mark/space length discrimination circuit for discriminating mark and space lengths lying over a recording medium from information recorded in the recording medium;
a laser pulse train generating circuit for determining a shape of a laser pulse train from the output of the mark/space length discrimination circuit;
a change timing signal generating circuit for outputting a plurality of change timing signals each based on a binary pulse train, indicative of change timings each corresponding to an amount of light emitted by a laser on the basis of the laser pulse train outputted from the laser pulse train generating circuit; and
an encode circuit for converting the change timing signals to code signals based on a predetermined conversion table and outputting each of the signals to a signal transmission path.

20. The signal processing LSI according to claim 19,
wherein each of conversion tables used for conversion of the change timing signals and the code signals at the encode circuit is changeable programmably from a microcomputer lying inside or outside the signal processing LSI.

21. A laser driver comprising:
a decode circuit for converting code signals each inputted via a signal transmission path to a plurality of change timing signals each corresponding to an amount of light emitted by a laser, based on a predetermined conversion table; and
a laser drive circuit for generating a laser drive current for forming a laser pulse train, based on the change timing signals outputted from the decode circuit.

22. The laser driver according to claim 21,
wherein each of conversion tables used for conversion of the code signals and the change timing signals at the decode circuit is changeable programmably from a microcomputer lying inside or outside the laser driver.

23. The optical disk apparatus according to claim 1,
wherein laser power or laser waveforms prior and subsequent to a given time are identical to each other, and
wherein the code signals prior and subsequent to the time are different from each other.

24. The information recording method according to claim 10,
wherein laser power or laser waveforms prior and subsequent to a given time are identical to each other, and
wherein the code signals prior and subsequent to the time are different from each other.
